(19) United States
(12) Patent Application Publication
(10) Pub. No.: US 2010/0187835 A1
(43) Pub. Date: Jul. 29, 2010

(54) Electromagnetic Energy Scavenger Based on Moving Permanent Magnets

(75) Inventors: Dennis Hohlfeld, Veldhoven (NL); Ruud Vullers, Waalre (NL)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: STICHTING IMEC NEDERLAND, Eindhoven (NL)

(21) Appl. No.: 12/665,874

(22) PCT Filed: Jun. 26, 2008
(86) PCT No.: PCT/EP08/58194

§ 371 Date: Dec. 21, 2009

Related U.S. Application Data
(60) Provisional application No. 60/947,203, filed on Jun. 29, 2007.

(51) Int. Cl. F03G 7/08; H02K 35/02

(52) U.S. Cl. 290/1 R; 310/28

(57) ABSTRACT

An electromagnetic energy scavenger (10) for converting kinetic energy into electrical energy comprises at least one permanent magnet (12) and one or more coils (11) lying in a coil plane, the one or more coils being electrically interconnected for delivery of electrical energy. Upon mechanical movement of the energy scavenger (10), the at least one permanent magnet (12) is freely movable relative to the coils (11) in a plane parallel to the coil plane, thus generating an electrical field in at least one coil (11).

### TECHNICAL FIELD OF THE INVENTION

This invention generally relates to a method for generating energy by electromagnetic means and to a device or energy scavenger for generating energy by electromagnetic means. The electromagnetic energy scavengers of the present invention may be miniaturized based on microfabrication techniques. The energy scavengers may for example be used in wireless systems such as wireless autonomous transducer systems, e.g. for powering wireless autonomous sensors.

### BACKGROUND

Future wireless sensor networks will comprise sensor nodes which occupy a volume of typically a few cm³. The scaling down of batteries for powering these sensor nodes faces technological restrictions as well as a loss in storage density. For this reason a worldwide effort is ongoing to replace batteries with more efficient, miniaturized power sources. Energy scavengers based on the recuperation of wasted ambient energy are a possible alternative to batteries. Several scavenger concepts have been proposed, based on the conversion of thermal energy, pressure energy or kinetic energy.

Kinetic energy scavengers convert energy in the form of mechanical movement (e.g., in the form of vibrations or random displacements) into electrical energy. For conversion of kinetic energy into electrical energy, different conversion mechanisms may be employed, for example based on piezoelectric, electrostatic or electromagnetic mechanisms. Piezoelectric scavengers employ active materials that generate a charge when mechanically stressed. Electrostatic scavengers utilize the relative movement between electrically isolated charged capacitor plates to generate energy. Electromagnetic scavengers are based on Faraday's law of electromagnetic induction and generate electrical energy from the relative motion between a magnetic flux gradient and a conductor. For example, a voltage is induced across an electromagnetic coil when the magnetic flux coupled to the coil changes as a function of time.

Prior art electromagnetic scavenging approaches often use a resonant damped spring mass system for harvesting energy from periodic vibration or impact pulses. In “Vibration based electromagnetic micropower generator on silicon”, Journal of Applied Physics, Vol. 99, 2006, Kulkarni et al. describe a microfabricated electromagnetic scavenger which features a silicon paddle carrying a single coil. This component is suspended by means of a silicon cantilever to a vibrating frame and enclosed between an arrangement of four permanent magnets that are at a fixed position. Upon application of external vibration, the silicon paddle with the coil resonates between the fixed permanent magnets, thereby inducing a flux gradient and hence generating a voltage. The size and the structure of the generator limit the maximum displacement of the paddle. For efficient energy conversion, the resonant frequency of the electromagnetic power generator should match the frequency of external vibrations. However, real vibration sources typically show a considerable amount of energy apart from the resonant frequency. Moreover, since resonant generators have usually one degree of freedom, the vibration direction should match the sensitive direction of the energy transducer.

In “Vibrational energy scavenging with Si technology electromagnetic inertial microgenerators”, C. Serre et al., Microsystem Technologies, Vol 13, p. 1655, 2007, an electromagnetic inertial microgenerator is described with a fixed micromachined coil and a movable magnet mounted on a resonant membrane. Again, the maximum displacement of the magnet relative to the coil is limited by the size and the structure of the generator. For efficient operation the resonant frequency of the generator should match the frequency of external vibration and the vibration direction should match the sensitive direction of the generator.

Miniaturized electromagnetic scavengers based on resonant mechanical systems amplify small input displacements into useful vibration amplitudes. The applicability of these systems is limited to the bandwidth of their mechanical resonance. Miniaturized resonant systems can hardly be designed for frequencies lower than 50 Hz, as e.g. encountered in human body motion or long stroke machine operation. This is due to the fact that the required mechanical parameters, i.e. high mass and low suspension stiffness, are difficult to obtain with the dimensions of miniaturized systems.

In “Non-resonant vibration conversion”, Journal of Micromechanics and Microengineering, Vol. 16, 5169, 2006, D. Spreeman et al. propose an electromagnetic scavenger based on a non-resonant conversion mechanism. This approach is based on the conversion of linear vibration into a rotary motion. The mechanical excitation of the generator housing leads to the rotation of a pendulum on which a permanent magnet is mounted. When the pendulum rotates, the magnet causes a change of magnetic flux in circularly arranged stator coils, thereby inducing a voltage. However, it is a disadvantage of the Spreeman system that there is a need for converting a linear motion into rotation of the pendulum. When starting from rest, full rotation is only obtained when the ratio of the vibration amplitude to the pendulum length is sufficiently high. Therefore, proper operation of the scavenger may require applying an initial angular rate (depending on the geometry and the vibration amplitude). The magnet is attached to a pendulum which is physically connected to the rest of the system. Therefore, the movement of the magnet is restricted to a fixed trajectory.

Miniaturization, as required for use in wireless sensor nodes, is expected to be challenging because the mechanism requires a bearing which can hold relatively high moments.

### SUMMARY OF THE INVENTION

It is an object of embodiments of the present invention to provide good apparatus or methods for generating energy by electromagnetic means.

The above objective is accomplished by a method and device according to the present invention.

The present invention provides a method for converting kinetic energy into electrical energy by electromagnetic means based on the movement of a permanent magnet relative to one or more coils, e.g. an array of coils, lying in a coil plane. The mechanical movement provides a free movement of the at least one magnet in a plane parallel to the coil plane. With a free movement is meant that the magnet is free to move within the boundaries of a scavenger, i.e. it is not suspended, not fixed to another part of the scavenger, such as e.g. a frame or a membrane or a pendulum or a bearing. The free movement may be a sliding movement of the permanent magnet with respect to the one or more coils.

The method according to embodiments of the present invention allows for efficient power generation under non-harmonic, arbitrary movements, e.g. shocks, as well as under harmonic vibrations.

The present invention further provides an electromagnetic energy scavenger for converting kinetic energy into electrical energy, wherein the energy scavenger may operate under non-harmonic, arbitrary movements. An electromagnetic energy scavenger according to embodiments of the present invention comprises at least one permanent magnet and one or more coils lying in a coil plane, the one or more coils being electrically interconnected for delivery of electrical energy, wherein, upon mechanical movement of the energy scavenger, e.g. vibration such as environmental vibration like vibrations by operating machines, the at least one permanent magnet is freely movable relative to the coils in a plane parallel to the coil plane, thus generating an electrical field in at least one coil, e.g. a voltage across the one or more coils.

An energy scavenger according to embodiments of the present invention has two degrees of freedom and enables energy generation from in-plane motion. The relative displacement of the magnet relative to the coils is relatively large. As opposed to prior art systems, there is no (indirect) physical connection between the magnet(s) and the coil(s) in a system according to embodiments of the present invention.

Furthermore, an electromagnetic scavenger according to embodiments of the present invention may easily be miniaturized, for example based on micromachining or MEMS (Micro-Electro-Mechanical Systems) technology. In a scavenger according to embodiments of the present invention, there is no need for adapting the scavenger so as to match the vibration frequency. Furthermore, it is an advantage of some embodiments of the present invention that they do not require a matching of the sensitive direction of the scavenger to the direction of the mechanical movement, e.g. vibration direction.

The scavenger includes at least one electromagnetic coil, the at least one coil being electrically interconnected and lying in a coil plane, and at least one permanent magnet acting as a seismic mass. Preferably, the scavenger includes a plurality of coils that are electrically interconnected and lying in a coil plane. The at least one permanent magnet may move freely in a plane parallel to the plane of the at least one coil, within the boundaries of the scavenger. Arbitrary movements of the electromagnetic scavenger may induce sliding of the at least one permanent magnet in a sliding plane parallel to the coil plane, thereby causing a change in magnetic flux through the at least one coil and inducing a voltage across the at least one coil.

An electromagnetic energy scavenger in accordance with embodiments of the present invention may comprise a plurality of coils, the plurality of coils being electrically interconnected. In embodiments of the present invention, the plurality of coils may be arranged in a one-dimensional array, in a plurality of one-dimensional arrays or in a two-dimensional array. Other arrangements are possible. For example, the plurality of coils may be arranged in a plurality of one-dimensional arrays, and a permanent magnet may be provided for each of the plurality of one-dimensional arrays.

An electromagnetic energy scavenger in accordance with embodiments of the present invention may be adapted for, upon arbitrary mechanical movement of the electromagnetic scavenger, inducing sliding of the at least one permanent magnet in a sliding plane parallel to the coil plane.

In embodiments of the present invention, repelling means may be provided for confining the sliding of the at least one permanent magnet parallel to the coil plane, to a predetermined zone within the boundaries of the scavenger, the predetermined zone overlaying at least one of the at least one coil. The repelling means may be arranged along a perimeter of the predetermined zone. Magnetic springs or mechanical cantilevers may be used as repelling means.

Furthermore, means may be provided for restricting movement of the at least one permanent magnet in a direction non-parallel to, e.g. perpendicular to, the coil plane. For example, at least one plate substantially parallel to the coil plane may be provided. An upper plate and a lower plate may be provided. The means for restricting movement of the at least one permanent magnet in a direction non-parallel to the coil plane, e.g. the at least one plate, may comprise a low-friction coating for minimizing energy losses during motion, e.g. sliding motion, of the at least one permanent magnet.

In embodiments of the present invention, at least one soft magnetic layer may be provided in a plane parallel to the coil plane for improving the magnetic flux confinement to the at least one coil. The at least one soft magnetic layer may comprise a plurality of segments.

These as well as other aspects and advantages will become apparent to those of ordinary skill in the art by reading the following detailed description, with reference where appropriate to the accompanying drawings which illustrate, by way of example, the principles of embodiments of the present invention. Further, it is understood that this description is merely an example and is not intended to limit the scope of the invention as claimed. The reference figures quoted below refer to the attached drawings.

### BRIEF DESCRIPTION OF THE DRAWINGS

FIG. 1 is a schematic presentation of an electromagnetic scavenger according to embodiments of the present invention. A permanent magnet acts as a seismic mass. Spring elements confine its motion either to a linear region (FIG. 1(a)) or to the region of an array of coils (FIG. 1(b)).

FIG. 2 is an illustration of a circular magnet which partially overlaps the footprint of a circular coil, whereby the intersection between the contour of the coil and the contour of the magnet, in a direction defined by a line between the centres of the magnet and the coil, occurs at a point between the magnet's center point and the coil's centre point.

FIG. 3 is an illustration of a circular magnet which partially overlaps the footprint of a circular coil, whereby the intersection between the contour of the coil and the contour of the magnet, in a direction defined by a line between the centres of the magnet and the coil, occurs at a location that is not between the magnet's center point and the coil's centre point.

FIG. 4 is an illustration of a circular magnet which fully overlaps the footprint of a circular coil, there being no overlap between the contours of both elements.

FIG. 5 shows the results of a simulation of the normalized overlap area between a circular magnet and a circular coil at different spacing and for three diameters of the circular magnet.

FIG. 6 shows the result of a simulation of the induced voltage when a permanent magnet slides over a single coil at 1 m/s, wherein the magnet and the coil have a diameter of 1 mm, for a coil with 100 windings and a flux density of 1T.

FIG. 7 is a schematic representation of a linear arrangement of coils. Adjacent coils have alternate winding directions.

FIG. 8 shows the results of a simulation of the overlap area (solid line) and the change in overlap area (dashed line) for a linear arrangement of circular coils wherein adjacent coils have alternate winding directions, only considering coils with a first winding direction, and using a circular magnet with the same size as the coils.

FIG. 9 shows the results of a simulation of the overlap area (solid line) and the change in overlap area (dashed line) for a linear arrangement of circular coils wherein adjacent coils have alternate winding directions, only considering coils with a second winding direction, and using a circular magnet with the same size as the coils.

FIG. 10 shows the calculated output voltage of a scavenger according to embodiments of the present invention, if two sets of linear coil arrays as in FIG. 8 and FIG. 9 are combined.

FIG. 11 is a schematic view of a permanent magnet with a partial overlap with a microcoil. The overlap is different for every coil winding.

FIG. 12 shows the calculated output voltage of a scavenger according to embodiments of the present invention, wherein the permanent magnet slides over a linear array of microcoils.

FIG. 13 illustrates a motion path of a sliding permanent magnet over a two-dimensional array of coils.

FIG. 14 shows the result of a simulation of the output voltage of a two-dimensional scavenger in accordance with embodiments of the present invention.

FIG. 15 is a schematic illustration of an embodiment of the present invention with a soft magnetic layer underneath the coils.

FIG. 16 shows an embodiment of the present invention with one soft magnetic layer underneath all coils.

FIG. 17 is a schematic view of a magnetic layer with easy-axis magnetization (indicated by arrows) parallel to the magnet movement in one dimension.

FIG. 18 is a schematic view of a magnetic layer with easy-axis magnetization (indicated by arrows) perpendicular to the magnet movement in one dimension.

FIG. 19 shows the magnetization curve of the magnetic layer according to an embodiment of the present invention wherein the easy-axis magnetization of the magnetic layer is parallel to the magnet movement in one dimension.

FIG. 20 shows the magnetization curve of the magnetic layer according to an embodiment of the present invention wherein the easy-axis magnetization of the magnetic layer is perpendicular to the magnet movement in one dimension.

FIG. 21 is a schematic presentation of a magnetic layer with easy-axis magnetization (indicated by arrows) in two dimensions.

FIG. 22 shows the magnetic field distribution of two permanent magnets in close proximity.

FIG. 23 shows the repelling force between two magnets of different field densities versus displacement.

FIG. 24 illustrates the impact of guiding soft magnetic material underneath the coils.

FIG. 25 is a schematic view of a demonstrator for linear motion of a magnet, according to embodiments of the present invention.

FIG. 26 is schematic view of coil dimensions in comparison to the magnet's size.

FIG. 27 shows the output voltage and output power measured for the demonstrator of FIG. 25 as a function of the frequency of a vertical sinusoidal excitation and for different acceleration amplitudes, for a device with nine coils of type C (as defined in table 1).

FIG. 28 shows the output voltage and output power measured for the demonstrator of FIG. 25 as a function of the frequency of a vertical sinusoidal excitation and for different acceleration amplitudes, for a device with thirteen coils of type B (as defined in table 1).

FIG. 29 shows the transient characteristics of the voltage output at a vertical excitation frequency of 6.2 Hz for a device with nine coils of type C (as defined in table 1).

FIG. 30 shows the transient characteristics of the voltage output at a vertical excitation frequency of 6 Hz for a device with thirteen coils of type B (as defined in table 1).

In the different figures, the same reference signs refer to the same or analogous elements.

### DETAILED DESCRIPTION

The present invention will be described with respect to particular embodiments and with reference to certain drawings but the invention is not limited thereto. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising” should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B.

The present invention is related to a method for converting kinetic energy into electrical energy by electromagnetic means, based on the free movement of at least one permanent magnet relative to one or more coils, e.g. an array of coils. The method allows efficient power generation under non-harmonic, arbitrary movements. The present invention is furthermore related to an electromagnetic scavenger for converting arbitrary movements into electrical energy, the electromagnetic scavenger having two degrees of freedom and potentially enabling energy generation from in-plane motion. An electromagnetic scavenger according to embodiments of the present invention may be miniaturized, for example based on MEMS technology.

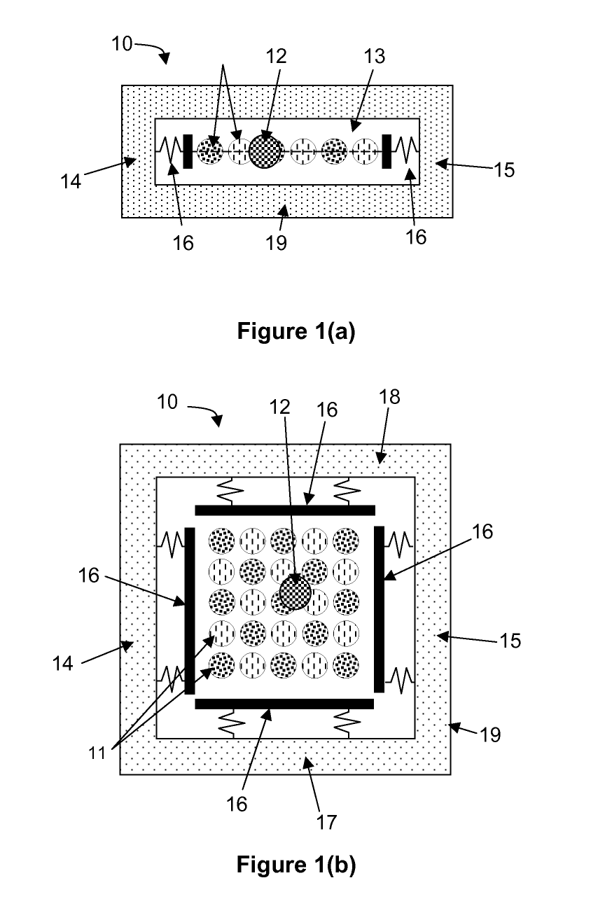

As shown in FIG. 1, an energy scavenger 10 in accordance with embodiments of the present invention comprises at least one coil 11, e.g. an array of coils, e.g. an array of microcoils, substantially lying in a plane, further called the coil's plane, and at least one permanent magnet 12, which may act as a seismic mass. The permanent magnet 12 is not suspended or fixed to another part of the scavenger and can thus freely move, e.g. slide in a slide plane, being a plane parallel to the coils' plane, and in close proximity to the coils' plane. The distance between the permanent magnet 12 and the coils 11 may for example be in the range between 100 μm and 1 mm, e.g. in the range between 100 μm and 500 μm. The configuration may be such that the permanent magnet 12 can move in one dimension (as shown in FIG. 1(a)) or it may be such that the permanent magnet can move in two dimensions (as shown in FIG. 1(b)). In the first case (1D movement), the permanent magnet 12 slides within a channel 13 of which both ends 14, 15 feature a repelling element 16. The repelling element 16 may be, for example, a spring. In the second approach (2D movement), motion of the permanent magnet 12 in a 2D plane is possible and the four sides 14, 15, 17, 18 of the plane feature repelling elements 16. The at least one coil 11, e.g. the array of coils 11, may be surrounded by a frame 19, onto which the repelling elements 16 may be fixed. Motion of the permanent magnet 12 in a direction not parallel to the coils' plane, may be restricted by closing the movement area, e.g. sliding area, for example with an upper plate (not illustrated in the drawings) and/or a lower plate (not illustrated in the drawings), for example resting on and/or attached to the frame 19. In order to minimize energy losses during motion, both the lower plate and/or upper plate may feature a low-friction coating.

As described above, the motion of the permanent magnet 12 may be confined to the area of the array of coils 11 by means of repelling elements 16, such as springs. The springs 16 can be, for example, mechanical cantilevers or magnetic springs. In the latter case, additional permanent magnets are placed at the outer boundary of the sliding area. The additional permanent magnets may have the same polarization as the sliding permanent magnet. The additional permanent magnets placed at the outer boundary of the sliding plane generate a repelling force when the sliding permanent magnet of equal polarization is approaching. The magnetic springs offer the advantage that mechanical contact between the frame and the sliding permanent magnet can be prevented. This is expected to be beneficial to the lifetime of the whole system.

If mechanical cantilevers are used as repelling elements 16, a monolithic device can be fabricated. Through micromaching of semiconductor material, e.g. silicon, for example, or other suitable materials, it is possible to fabricate the cantilevers and the frame 19 from one single substrate, possibly in parallel with other devices. In case of a micromachined scavenger, the total footprint of the miniaturized device may for example be in the order of 1 cm². The frame 19 and the repelling elements 16, e.g. springs, may be fabricated by means of micromachining techniques. The at least one coil 11 may be a microcoil. Fabrication of microcoils is a well established technique. Microcoils can, for example, be made by electroplating in semiconductor, e.g. silicon, or polymer moulds or they can be printed. Strong permanent disc-shaped magnets 12 are commercially available with a field density of up to 1 T. Additional soft-magnetic components (as described further) can be either electroplated, physically deposited or precision machined from thin metal sheets.

The principle of a scavenger 10 according to embodiments of the present invention is based on an arrangement of at least one coil 11, preferably multiple coils 11 and a sliding permanent magnet 12. The coils 11 may, for example, be placed in a row (as shown in FIG. 1(a)) or in a two-dimensional array (as shown in FIG. 1(b)). The coils 11 may be electrically connected in series. Arbitrary movements of the scavenger 10 may induce movement of the permanent magnet 12 in the sliding plane. Each time the sliding permanent magnet 12 passes a coil 11, the magnetic flux through the coil 11 changes and a voltage pulse is induced. A coil 11 generates a voltage signal when the permanent magnet 12 moves, in embodiments of the present invention slides, over it. The amplitude of the generated voltage depends on the magnetic flux variation through the coil 11, which itself depends on the coil's inductance, the magnet's field density and the magnet's velocity. The total output power also depends on the coil's electrical resistance.

In particular embodiments of the present invention, all coils 11 are electrically connected in series. It is beneficial to arrange the coils 11 in such a way that they have alternate winding directions (i.e., in such a way that neighboring coils 11 have a different winding direction). For example, when a coil 11 has a clockwise winding direction, its neighboring coil(s) 11 may have a counterclockwise winding direction. Alternatively, when a coil 11 has a counterclockwise winding direction, its neighboring coils 11 may have a clockwise winding direction.

The expected output voltage of an electromagnetic scavenger 10 according to embodiments of the present invention has been modeled for a configuration wherein the at least one coil 11, e.g. the plurality of coils 11, and the permanent magnet 12 have a circular shape. Modeling is based on the geometrical analysis of the overlapping area of two circles. A voltage or electromotive force is generated within a coil 11 when the linked magnetic flux changes over time, the flux being generated by the sliding permanent magnet 12. The change in magnetic flux may be due to a change in the overlap area between the coil 11 and the permanent magnet 12 or due to a change in magnetic field density. The electromotive force e.m.f. is given by formula (1), wherein B is the magnetic field density and A is the overlap area between the coil 11 and the magnet 12.

$$e . m . f . = \frac{\partial }{\partial t} {\int }_{coil} B d A \qquad ( 1 )$$

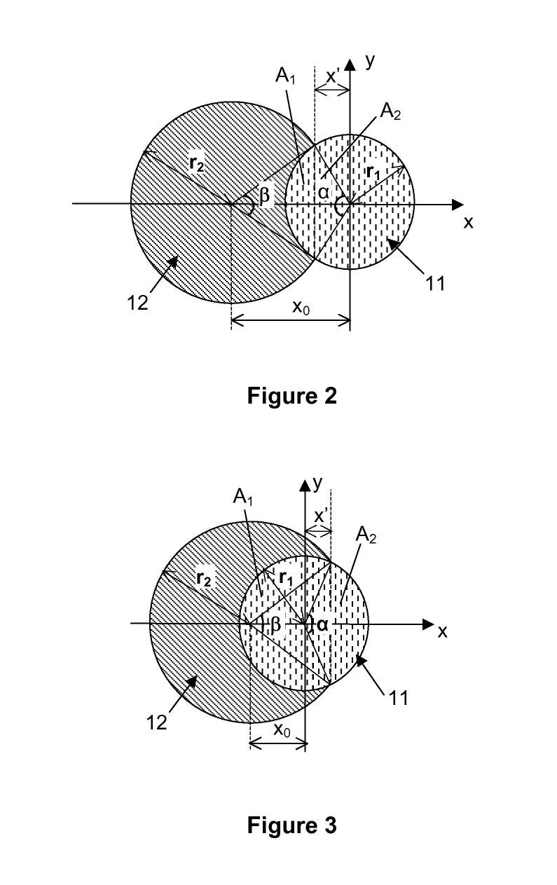

In order to calculate the induced voltage, the change in flux through the coil 11 with respect to time has to be determined. In simulations performed, it is assumed that the field density B of the permanent magnet does not change over time. FIG. 2 illustrates a magnet 12 which partially overlaps the footprint of a coil 11. This setup was modeled by assuming that the magnet 12 and the coil 11 have the shape of a circle with radii r₂ (magnet 12) and r₁ (coil 11) respectively. In the x-y plane, as indicated in FIG. 2, the center point of the magnet 12 has coordinates (x₀,0) and the center point of the coil has coordinates (0,0). Their spacing (i.e., the spacing between the center point of the magnet 12 and the center point of the coil 11) is then given by x₀. The contours of both elements (i.e., the contour of the magnet 12 and the contour of the coil 11) intersect at two points: (x′,−y′) and (x′,+y′).

Depending on the values of x₀ and x′, different situations have to be addressed. In a first case, when |x₀|>r₁+r₂ is fulfilled, no overlap is present between the magnet 12 and the coil 11. The spacing x₀ between the center points is bigger than the sum of the radii. As there is no overlap between both circles, no change in overlap area has to be determined. In a second case, when |x₀|<r₁+r₂ is true, both circles overlap at least partially.

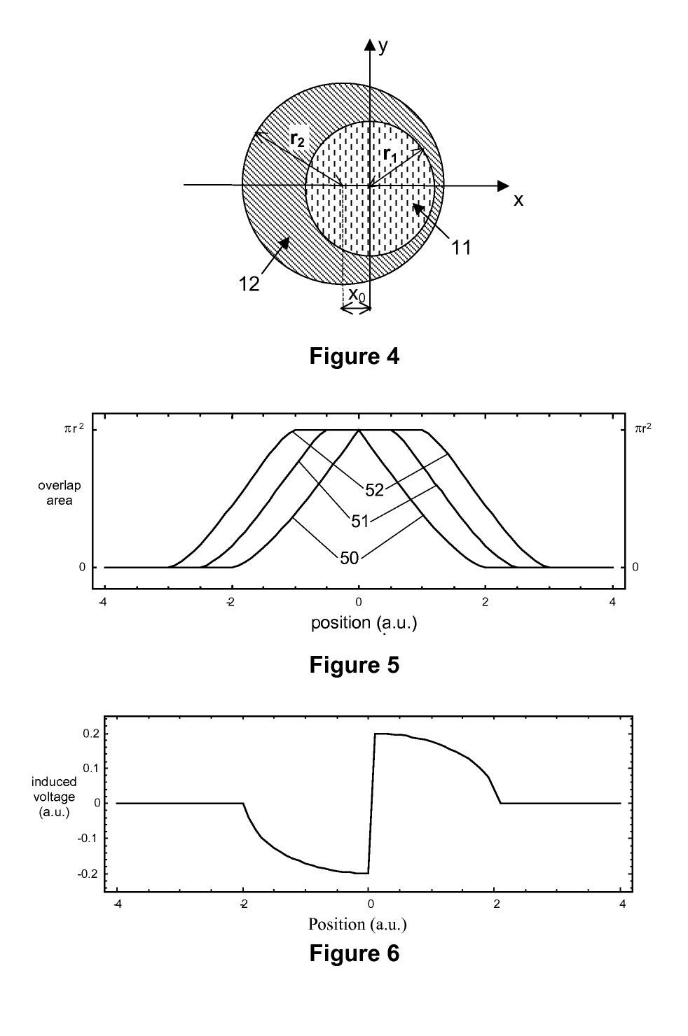

For further geometrical analysis, three situations have to be differentiated, as shown in FIGS. 2, 3 and 4. FIG. 2 shows a situation wherein |r₂−r₁|=|x₀| and x₀·x′>0, meaning that the intersection between the contour of the coil 11 and the contour of the magnet 12 occurs at a point between the magnet's center point and the coil's center point. In the situation illustrated in FIG. 3, |r₂−r₁|=|x₀| and x₀·x′<0, meaning that the intersection between the contour of the coil 11 and the contour of the magnet 12 occurs at a location that is not in between the magnet's center point and the coil's center point. In a third situation, shown in FIG. 4, |r₂−r₁|>|x₀| and there is no intersection between the contour of the coil 11 and the contour of the magnet 12. In the case shown, the diameter of the magnet 12 is larger than the diameter of the coil 11 and the magnet 12 fully overlaps the footprint of the coil 11.

The intersection points (x′, y′) and (x′, −y′) between the contour of the magnet 12 and the contour of the coil 11 can be easily derived through the two equations which define the circles:

(x−x₀)²+y²=r₂²

x²+y²=r₁² (2)

wherein the first equation describes the contour of the magnet 12 and the second equation describes the contour of the coil 11. By solving for x and y, the intersection points may be determined:

$${x}^{′} = \frac{{r}_{1}^{2} - {r}_{2}^{2} + {x}_{0}^{2}}{2 {x}_{0}} , {y}^{′} = \pm \sqrt{{r}_{1}^{2} - {x}^{′ 2}} \qquad ( 3 )$$

In case the intersection points are located between the magnet's and coil's center points (|r₂−r₁|=|x₀| and x₀·x′>0, see FIG. 2), the overlap area between the magnet and the coil is the sum of areas A1 and A2 shown in FIG. 2. The areas A₁ and A₂ can be determined to be:

$${A}_{1} = \frac{1}{2} ( α - sin α ) {r}_{1}^{2} , {A}_{2} = \frac{1}{2} ( β - sin β ) {r}_{2}^{2} \qquad ( 4 )$$

with the angles α and β expressed in radians and given by:

$$cos α / 2 = \frac{\vert {x}^{′} \vert}{{r}_{1}} , cos β / 2 = \frac{\vert {x}_{0} - {x}^{′} \vert}{{r}_{2}} \qquad ( 5 )$$

In case the intersection points are not located between the magnet's and coil's center points (|r₂−r₁|=|x₀| and x₀·x′<0, see FIG. 3) the areas A₁ and A₂ can be determined to be:

$${A}_{1} = [ π - \frac{1}{2} ( α - sin α ) ] {r}_{1}^{2} , {A}_{2} = \frac{1}{2} ( β - sin β ) {r}_{2}^{2} \qquad ( 6 )$$

With this set of equations, it is possible to determine the overlap area of two circles of different radii r₁, r₂ at any given distance between the circles' center points. FIG. 5 shows the normalized overlap area (diameter r₁ of coil 11=1) for two circles as a function of the distance between their center points and for three diameters of the magnet 12 (r₂=1−curve 50, r₂=1.5−curve 51 and r₂=2−curve 52). From FIG. 5 it can be concluded that, as soon as there is overlap between the two circles, the overlap area increases substantially linearly as a function of the distance between the center points until there is full overlap. The further decrease in overlap area is also a substantially linear function of the distance between the center points of the circles. This may lead to the conclusion that for linear motion of a circular magnet 12 relative to a circular coil 11, a constant voltage may be induced. If a constant velocity v is assigned to the magnet 12, the magnet's position relative to the coil can be calculated at any point in time:

\vec{r}=\vec{v}·t (7)

Faraday's law can then be introduced:

$${U}_{ind} = - n \frac{\partial }{\partial t} \int B d A = - n B \frac{\partial A}{\partial t} \qquad ( 8 )$$

Here, U_{ind} is the voltage induced across the coil 11, n is the number of coil windings, B is the magnetic field density and A is the total overlap area between the magnet 12 and the coil 11. As A is evaluated numerically at specific locations it is straight-forward to compute ?A/?t. FIG. 6 shows the (calculated) induced voltage of a single coil 11 if the magnet 12 moves at 1 m/s relative to the coil 11 (with r₁=r₂=1 mm, n=100, B=1 T). In the example shown, the voltage is negative in the beginning as the overlap area A increases. As soon as the overlap area A is at its maximum, the voltage changes its sign and starts to decrease.

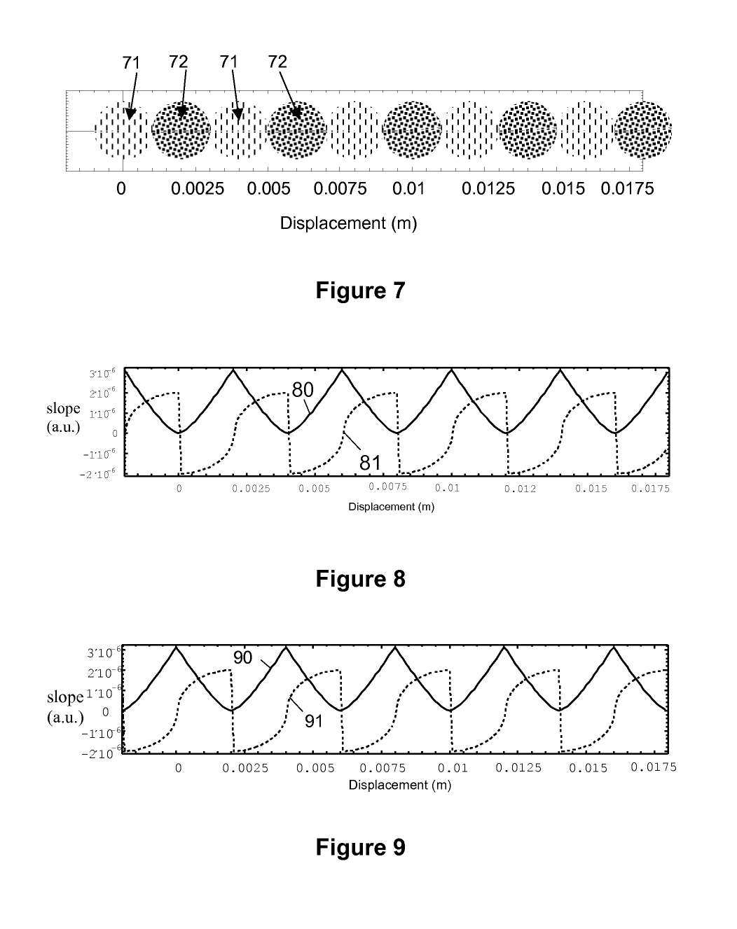

The principle of an electromagnetic scavenger 10 according to embodiments of the present invention is based on the arrangement of at least one coil 11, in embodiments of the present invention a plurality of coils 11, wherein the plurality of coils 11 are electrically connected and wherein each coil 11 generates a voltage signal when the permanent magnet 12 moves or slides over it. In a preferred embodiment, adjacent coils 11 may have alternate winding directions. That is, a coil 11 having a first winding direction may have neighboring coils 11 (2 in the case of a linear 1D array as illustrated in FIG. 1 or FIG. 7) with a second winding direction, where the second winding direction is opposite to the first winding direction. For example, the first winding direction may be a clockwise winding direction and the second winding direction may be a counterclockwise winding direction. Alternatively, the first winding direction may be a counterclockwise winding direction and the second winding direction may be a clockwise winding direction.

FIG. 8 shows the results of a simulation for a linear configuration, wherein the coils 71, 72 have alternate winding directions and wherein only the coils 71 with a first winding direction are considered (i.e., every second coil in the linear array of coils). These coils 71 are connected in series. FIG. 8 shows the overlap area (solid line 80) and the change in overlap area (dashed line 81) between these coils 71 and the magnet 12, assuming that a magnet 12 of the same size as the coils 71 is used. Due to the coil spacing of 2 r₂, with r₂ the radius of the magnet 12, a periodically varying characteristic is obtained, as shown in FIG. 8. The solid line 80 gives the overlap area between the magnet 12 and a coil 71 and the dashed line 81 corresponds to the change in overlap area. Analyzing the overlap area 90 and the change in overlap area 91 between the magnet 12 and the other coils 72 (i.e., the coils 72 with the second winding direction), a similar characteristic is obtained, which is shifted by half a period, as shown in FIG. 9.

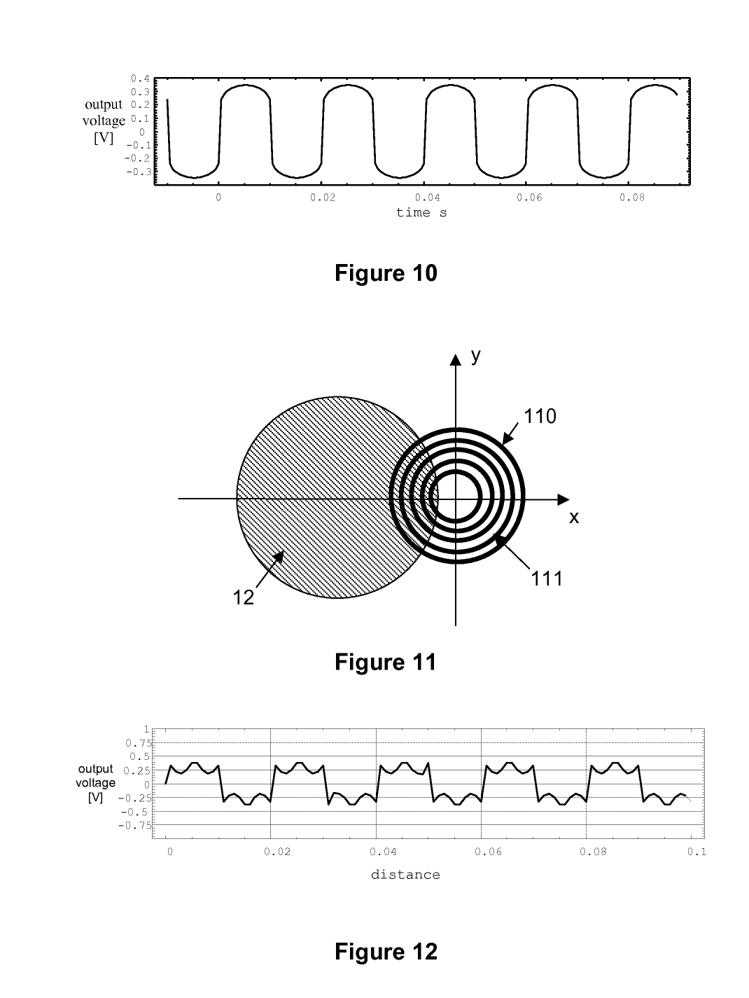

In particular embodiments of the present invention, the voltages of both sets of coils 71, 72 may be combined. This may be done physically by connecting all coils 71 with a first winding direction and all coils 72 with a second winding direction in series. The resulting voltage signal is shown in FIG. 10. The periodicity of the output voltage equals two coil diameters. Due to the simplicity of the present model the shape is almost rectangular. This characteristic eases rectification and further use of the output voltage for power conversion purposes.

A more realistic model should also consider the planar characteristics of e.g. microfabricated coils or microcoils 110. Such microfabricated coils 110 typically comprise a number of windings in a same plane, as illustrated in FIG. 11. The minimum realistic linewidth of a conductor path 111 of such a winding is approximately 5 μm. As the diameter of the coil 110 is set to be approximately 1 mm the total number of windings is limited. An increase in winding number is only possible if multiple coil levels are used (e.g., when the windings are located in a plurality of parallel planes). FIG. 11 is a schematic view of a permanent magnet 12 with a partial overlap with a microcoil 110 with a plurality of windings in a same plane, wherein the overlap area between the magnet 12 and the coil 110 is different for every coil winding.

An approach to model such planar microcoils 110 is to approximate the spiral coil as a set of concentric circles, as illustrated in FIG. 11. Consequently, the induced voltage is a superposition of the contribution of each individual winding. The total generated voltage can then be determined by applying the procedure described above on the plurality of windings. The impact on the waveform of the generated voltage is significant. This impact can be concluded from the simulation results shown in FIG. 12 when compared to FIG. 10. Despite the changes in signal waveform, the voltage is still usable for rectification and conversion. The overall effect as compared to FIG. 10 is that higher frequency components are present and that the effective voltage decreases, leading to a lower power output.

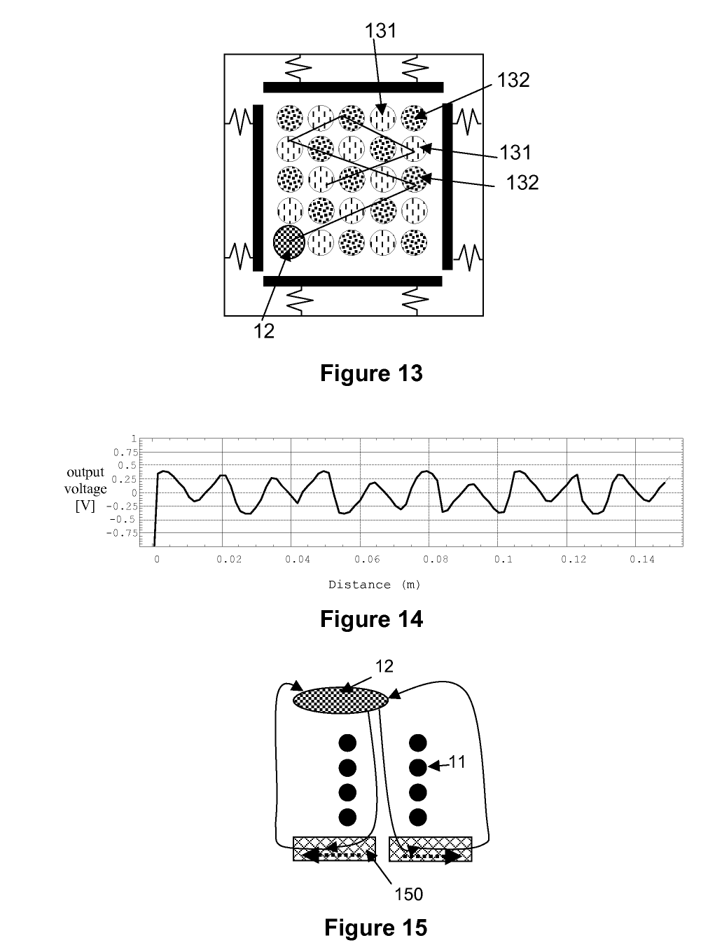

In order to enable scavenging from in-plane movements or vibrations, a two-dimensional setup of coils can be used, as shown in FIG. 13. Therefore, the modeling described above has to be extended in order to cover a magnet 12 which freely slides over a two-dimensional array of coils. The coils may all have the same winding direction and may be electrically connected in series. In alternative embodiments, neighbouring coils 131, 132 may have different winding directions, as illustrated in FIG. 13. In the following, linear motion of the magnet 12 under an arbitrary starting angle is considered, including correct change of direction after impact and rebound from the sidewalls of the scavenger. In this approach the magnet's trajectory is determined first, as shown in FIG. 13. Then the distance between the magnet 12 and each coil 131, 132 is determined by evaluating

|\vec{r}|=\vec{r}_{magn}−\vec{r}_{coil}(m,n) (9)

with \vec{r}_{magn} being the position of the magnet and \vec{r}_{coil}(m,n) giving the location of the coil at the m-th row and n-th column of the two-dimensional array of coils. The resulting voltage signal is shown in FIG. 14. As is apparent from this Figure, the signal quality further decreases if free linear motion in a 2D-plane is allowed for the permanent magnet 12. In addition, the signal's characteristic depends strongly on the initial direction vector.

Compared to the results shown in FIG. 10 and FIG. 12, the signal shown in FIG. 14 features a further reduced root-mean-square value. Therefore, it may be beneficial to restrict the motion of the permanent magnet to one dimension, wherein several linear channels comprising a plurality of coils may be arranged in parallel, each channel carrying an individual permanent magnet that may move in a direction corresponding to the longitudinal axis of the channel (embodiment not illustrated in the drawings). This configuration may then be combined with a second set of linear channels comprising a plurality of coils, the longitudinal axis of the second set of channels being rotated by 90 degrees relative to the longitudinal axis of first set of channels. In this way, each set of channels only harvests motion in a direction parallel to its longitudinal axis, but provides a voltage signal as shown in FIG. 10 or FIG. 12, which is much better suited for further processing as compared to the case where the permanent magnet can move freely in two dimensions (FIG. 14).

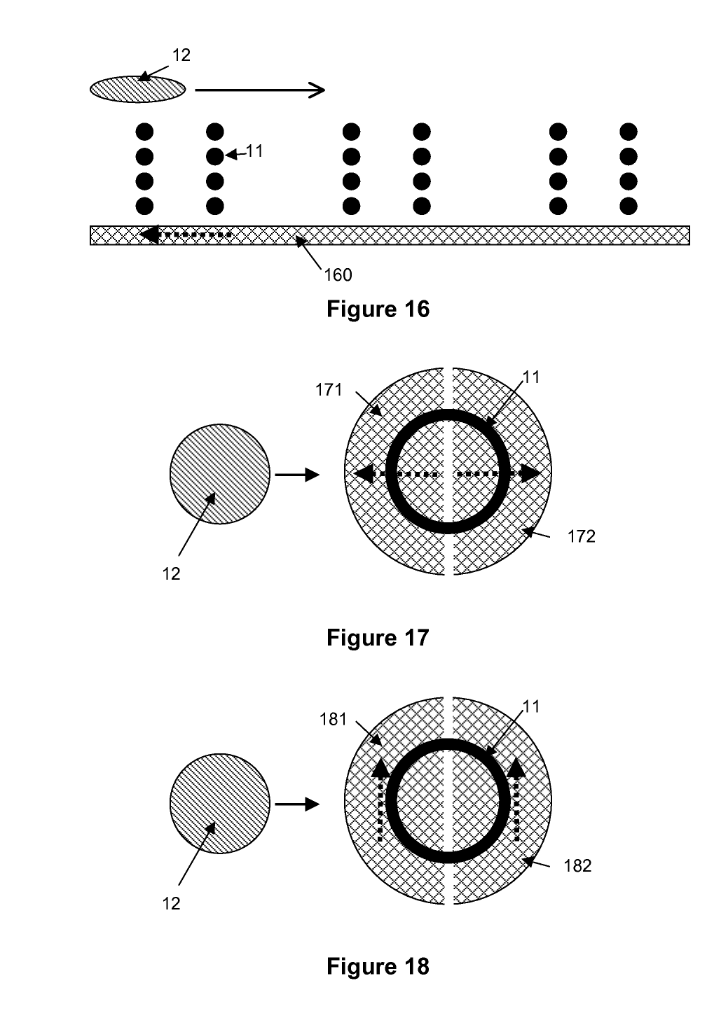

In embodiments of the electromagnetic scavenger 10 according to the present invention, the magnetic flux through the coils can be increased by adding a soft magnetic layer underneath the coils 11. This is illustrated in FIG. 15. In the example shown, the movement of the magnet 12 will cause alignment of the magnetization of the soft magnetic layer 150 to the field of the permanent magnet 12, as illustrated by the arrows in the soft magnetic layer 150. NiFe or CoZrNb can, for example, be used as soft magnetic materials. In embodiments of the present invention, one soft magnetic layer 160 underneath the whole array of coils may be provided, as illustrated in FIG. 16. For maximum effect, one may need sections of the soft magnetic layer with different magnetization directions. The soft magnetic layer may be a soft magnetic film, for example deposited in sections.

Due to the movement of the sliding magnet 12, a magnetic force is exerted on the soft magnetic layer 160. Soft-magnetic thin films as may be applied in the context of this invention often show an anisotropic permeability, meaning that the magnetic permeability, or flux guiding ability, is not equal in all directions. The highest permeability is found along a direction perpendicular to the easy-axis. Depositing the soft-magnetic film in an external magnetic field can enhance the anisotropy. The magnetic field during deposition determines the easy-axis direction, which will in any case be parallel to the plane of the magnetic layer.

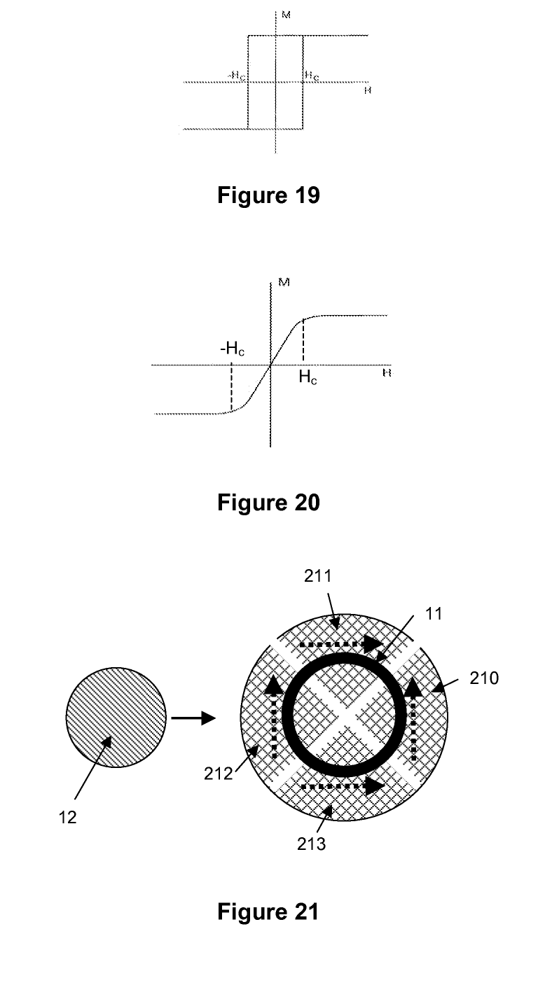

Examples of possible setups are illustrated in FIG. 17 and FIG. 18. In FIG. 17, the soft magnetic layer comprises a plurality of sections 171, 172 each having an easy-axis magnetization (indicated by the arrows) parallel to the sliding magnet movement in one dimension. In FIG. 18, the soft magnetic layer comprises one or more sections 181, 182 having an easy-axis magnetization (indicated by the arrows) perpendicular to the sliding magnet movement in one dimension. The magnetization curve of the material as obtained when the magnetic field is parallel to the easy-axis (corresponding to the setup of FIG. 17) is shown in FIG. 19. It can be seen that hysteresis takes place. The curve obtained when the magnetic field is perpendicular to the easy-axis (corresponding to FIG. 18) is shown in FIG. 20.

When a magnetic field H is applied in a direction parallel to the easy-axis, i.e. for the permanent magnet 12 moving in a direction parallel to the easy-axis, the flux guiding efficiency at values of the magnetic field strength H below the coercive force H_{c} is poor and the magnetization changes irregularly around the value of the coercive force H_{c}. Contrary, referring to FIG. 20, when the field is applied perpendicularly to the easy-axis, i.e. for the permanent magnet 12 moving in a direction perpendicular to the easy-axis, the magnetization reacts to the applied field with a rotation of the magnetization towards the direction of the applied field. The coercive force H_{c} is very low and the permeability at low values of the magnetic field strength H is high. Furthermore, a change in the direction (i.e., sign) of the magnetic field does not lead to substantial discontinuities in the value of the magnetic permeability. By choosing this second embodiment, the coercive force is relatively low and the permeability at low field strengths is relatively high.

In a 2D case, one may work optionally with as many soft magnetic layer segments as possible. In a configuration wherein the soft magnetic layer has an easy axis of magnetization in each segment different from the direction of the easy axis in an adjacent segment, a good working device may be obtained for different directions of the magnetic field (i.e., for different directions of movement of the permanent magnet 12). This means that, over a large part of the flux guiding material, the coercive force may be relatively low and the permeability at low field strengths may be relatively high. However, for practical reasons, the number of soft magnetic segments may be restricted to four sections 210, 211, 212, 213, as shown in FIG. 21.

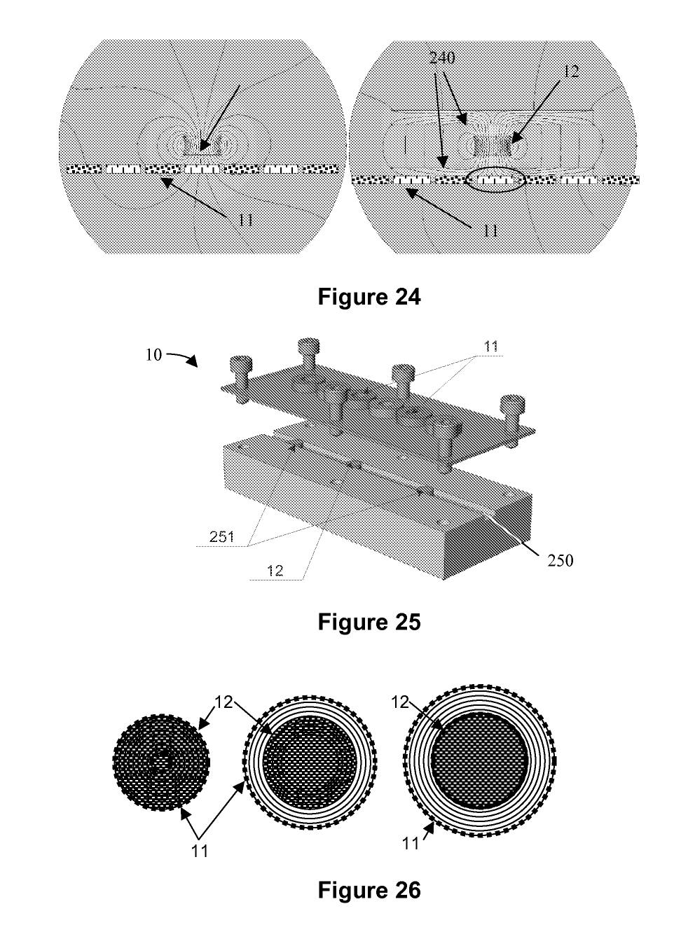

Based on simulations using the freeware tool femm 4.0.1, the integration of additional soft magnetic material 240 in the neighborhood of; e.g. underneath, the array of coils 11 proved to be beneficial in terms of guiding the magnetic flux. This improves flux linkage with the coils 11. The non-guided field distribution (see FIG. 24, left image) shows the diverging magnetic field lines. As in practical applications, the coil 11 may be located at a specific distance from the sliding magnet 12 it may not be passed by all field lines emerging from the magnet 12. This can be improved by the use of material with a high permeability. This effectively decreases the magnetic reluctance of the magnetic circuit and thereby improves the magnetic flux characteristics as shown in FIG. 24, right image.

As described above, in embodiments according to the present invention, magnetic springs may be used as repelling elements 16 for confining the sliding permanent magnet 12 to the area of the array of coils 11. The working principle of a magnetic spring is based on the repelling force of two permanent magnets of identical polarization. In embodiments of the present invention, additional permanent magnets are placed at the outer boundary of the sliding plane, the additional permanent magnets having the same polarization as the sliding permanent magnet 12. When the sliding permanent magnet 12 approaches a permanent magnet located at the outer boundary of the sliding plane, their magnetic fields are superimposed and the energy density strongly increases. This increase gives rise to a strong repelling force. Due to the inhomogeneous characteristic of the magnetic field which originates from a disc shaped permanent magnet 12, the repelling force changes non-linearly with spacing.

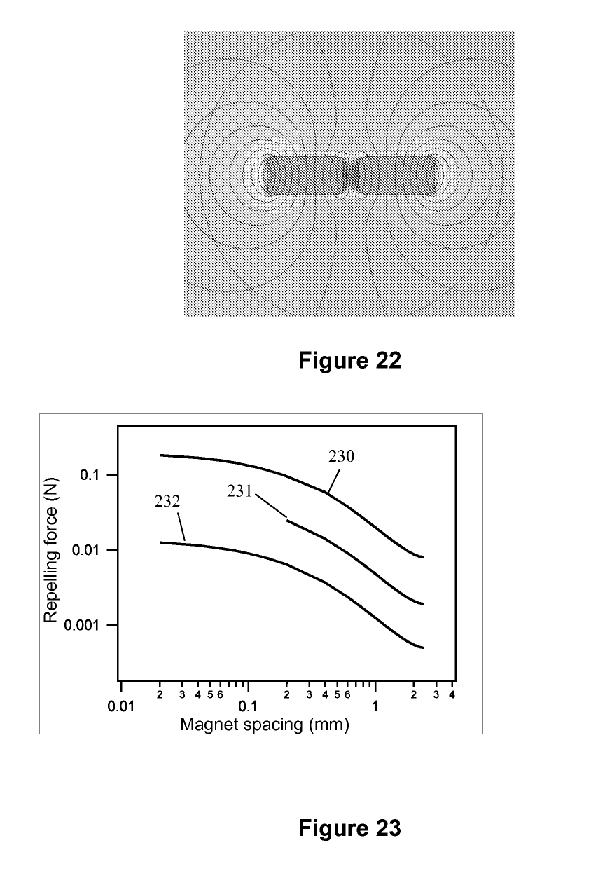

Preliminary numerical simulations (using the freeware tool femm 4.0.1) have been done to demonstrate the concept of magnetic springs and to determine the repelling force of two permanent magnets of identical polarization. The simulation results are shown in FIG. 22 and FIG. 23, and the results confirm that the repelling force is highly non-linear. An advantage of using magnetic springs is that mechanical impact can be completely prevented, as the repelling forces increase drastically if the spacing becomes very small. This is illustrated in FIG. 23 which shows repelling force in function of magnet spacing for magnets having different magnetic field strengths: 2T illustrated in curve 230, 1T illustrated in curve 231, or 0.5T illustrated in curve 232.

A macroscopic demonstrator of an electromagnetic scavenger according to embodiments of the present invention was fabricated using PMMA (Polymethyl methacrylate), as illustrated in FIG. 25. A Permanent magnet 12 and miniature coils 11 were assembled. A channel 250 is provided as a sliding area in which the permanent magnet 12 can freely slide in one dimension upon movement of the electromagnetic scavenger 10. The width of the channel comprising the permanent magnet 12 is 5 mm. Permanent magnets 251, acting as magnetic springs, are fixed at the end of the channel 250 comprising the permanent magnet 12. The permanent magnet 12 of the same polarization as the permanent magnets 251 can slide freely in the channel 250 in between the magnetic springs 251. The permanent magnets 251 have a height of 2 mm. The outer dimensions of the electromagnetic scavenger are 100 mm (length)×40 mm (width)×15 mm (height). The miniature coils 11 can be wound in three different design variations (type A, type B, type C) as shown in FIG. 26 and Table 1. Type A corresponds to the case where the outer radius of the coil 11 equals the magnet's radius. In type B, the magnet's radius is in between the coil's outer radius and the coil's inner radius. Finally, in type C the magnet's radius equals the inner radius of the coil 11. The winding number and wire diameter were adapted to yield an ohmic resistance of 50 O for each coil. This eases power matching during operation as a scavenger.

TABLE 1
Coil parameters for conventionally wound coils

| | Type A | Type B | Type C |
|---|---|---|---|
| | r₁ₒᵤₜ = r₂ > r_{1,in} | r₁ₒᵤₜ > r₂ > r_{1,in} | r₁ₒᵤₜ > r₂ = r_{1,in} |
| Wire diameter (mm) | 0.05 | 0.06 | 0.06 |
| Inner coil diameter | 1 | 3.2 | 5.1 |
| (mm) | | | |
| Outer coil diameter | 4 | 6 | 7.3 |
| (mm) | | | |
| Coil height (mm) | 2 | 2 | 2 |
| Winding number | 720 | 580 | 430 |
| Ohmic resistance | ~50 | ~50 | ~50 |
| (Ohm) | | | |

Two macroscopic demonstrators were assembled with coil dimensions of types B and C. The demonstrators were mounted vertically on a vibration test system (TIRA TV 52120), i.e. with the longitudinal direction of the channel 250 in a vertical direction. Therefore, the sliding magnet 12 experienced a constant gravitational force. At rest, the movable magnet 12 was in a position determined by its weight and the repelling force of the lower fixed magnet 251 acting as a magnetic spring. Under vibration excitation the sliding magnet 12 moved relatively to the channel 250 and the coils 11. This motion induced a voltage in the coils. The individual coils 11 were connected in series. The winding orientation of neighbouring coils was alternating, i.e. every second coil had a clockwise winding orientation whereas the other coils had an anticlockwise winding orientation.

The demonstrators were subjected to a sinusoidal motion with frequencies ranging from 5 Hz to 10 Hz. The acceleration amplitude was changed from 0.25 g to 0.6 g. This corresponded, depending on the frequency, to displacement amplitudes from 6 mm to 0.6 mm. The output voltage was measured between the terminals of the outmost coils. As the output was a non harmonic oscillating signal, an rms-value was measured using a digital multimeter. As the resistance of the coil assembly was known, the delivered power under matched load conditions could be calculated from the rms-value.

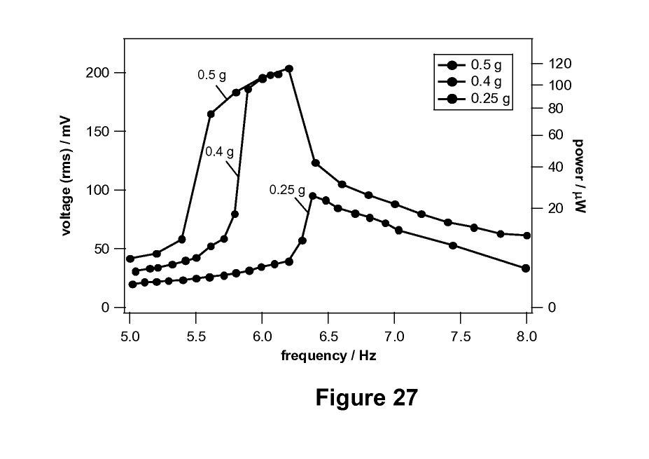

In FIG. 27 measurement results are shown as obtained with a demonstrator comprising nine coils of type C (as defined in table 1) connected in series, for three different excitation levels (acceleration amplitude 0.5 g, 0.4 g and 0.25 g). For each excitation level a similar behaviour of the voltage and power output as a function of the excitation frequency can be observed. At the lowest frequencies, the voltage and power output are only slightly increasing with frequency. In this frequency range the sliding magnet 12 experiences almost no motion relative to the coils 11, and its position is still influenced by the equilibrium of gravitational force and repelling force. At higher excitation frequencies a resonance-like behaviour can be seen. The frequency at which this type of behaviour starts is dependent on the excitation level. This resonance-like behaviour is related to the movement of the magnet 12 over the whole length of the channel 250, which leads to a significantly higher flux change through the coils 11 and thus to a higher voltage and power output. With increasing frequency the output voltage and power further increase. However, at a given frequency the oscillation of the magnet 12 becomes unstable and changes to a new state. In this state, although the fixed magnet 251 is vibrating together with the channel 250, the inertia of the sliding magnet 12 leads to a rest position (with respect to the global coordinates) wherein the flux change and thus the voltage output are only determined by the external vibration amplitude.

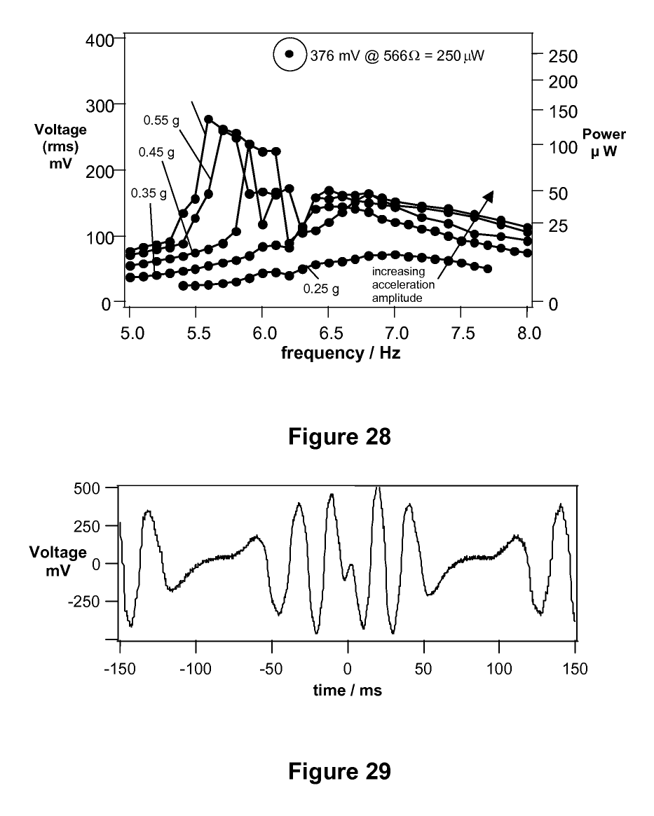

The results for the same experiment for a demonstrator with thirteen coils of type B (as defined in table 1) are shown in FIG. 28, for five different excitation levels (acceleration amplitude 0.60 g, 0.55 g, 0.45 g, 0.35 g and 0.25 g). The presence of a resonance-like behaviour is also observable in this case. For very low excitation levels (0.25 g) no ‘resonant’ state exists. For higher excitation, multiple frequency ranges with high output are present. At an excitation level of 0.6, and at a frequency of 6.2 Hz, an output power of 250 μW was reproducibly obtained. This effect seems to have a very narrow bandwidth as for lower and higher frequencies the oscillation decays rapidly to lower outputs.

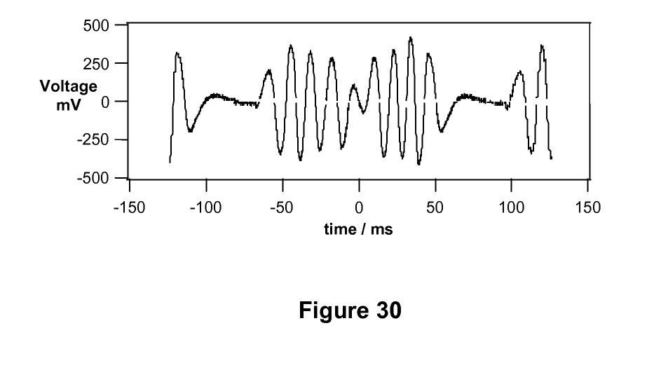

Due to the vertical direction of the magnet's motion in the experiments performed, the resulting transient voltage output signal is not fully harmonic. This is due to the asymmetry in the magnet's oscillation when approaching the upper and lower fixed magnets 251. The amplitude modulation is due to the fact that the velocity of the magnet varies while moving in the channel. Highest velocity and thus highest voltage output is generated when the position of the sliding magnet 12 is in between the fixed magnets 251, while at the reversal points the speed and voltage output decrease temporarily to zero. This leads to an amplitude modulation of the output signal as shown in FIGS. 29 and 30.

From the experimental results it can be concluded that a range of excitation frequencies exist where the sliding magnet 12 moves over the whole length of the channel 250, leading to the highest output voltage and power. This range of frequencies can for example be designed through suitable adjustments to the spacing of the two fixed magnets 251. The output energy of the energy scavenger is obtained as an amplitude and phase modulated harmonic signal.

Although a macroscopic scavenger device has been described hereinabove, the present invention is not limited thereto. It is an advantage of embodiments of the present invention that they can be miniaturized and made on millimeter scale, for example by means of micromachining or MEMS techniques. A MEMS-based scavenger may for example have a total footprint in the order of 1 cm² and may incorporate electroplated coils and miniature permanent magnets with diameter in the order of 1 mm. If mechanical cantilevers are used as repelling elements 16, a monolithic device can be fabricated. Through micromachining of semiconductor material, e.g. silicon, for example, or other suitable materials, it is possible to fabricate the cantilevers and the frame 19 from one single substrate, possibly in parallel with other devices. The frame 19 and the repelling elements 16, e.g. springs, may be fabricated by means of micromachining techniques. The at least one coil 11 may be a microcoil. Fabrication of microcoils is a well established technique. Microcoils can, for example, be made by electroplating in semiconductor, e.g. silicon, or polymer moulds or they can be printed. Strong permanent disc-shaped magnets 12 are commercially available with a field density of up to 1 T. Soft-magnetic layers can be either electroplated, physically deposited or precision machined from thin metal sheets.

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

1. An electromagnetic energy scavenger for converting kinetic energy into electrical energy, the electromagnetic energy scavenger comprising:
at least one permanent magnet;
one or more coils lying in a coil plane, the one or more coils being electrically interconnected for delivery of electrical energy, wherein, upon mechanical movement of the energy scavenger, the at least one permanent magnet is freely movable relative to the coils in a plane parallel to the coil plane, thus generating an electrical field in at least one coil; and
at least one soft magnetic layer in a plane parallel to the coil plane for improving the magnetic flux confinement to the at least one coil, the at least one soft magnetic layer comprising a plurality of segments.

2. The electromagnetic energy scavenger according to claim 1, wherein the at least one soft magnetic layer has an easy-axis of magnetization, and wherein this easy-axis of magnetization is parallel to the permanent magnet movement.

3. The electromagnetic energy scavenger according to claim 1, wherein the at least one soft magnetic layer has an easy-axis of magnetization, and wherein this easy-axis of magnetization is perpendicular to the permanent magnet movement.

4. The electromagnetic energy scavenger according to claim 1, wherein each segment has an easy axis of magnetization, the easy axis of magnetization in one segment being different from the easy axis of magnetization of the adjacent segment.

5. The electromagnetic energy scavenger according to claim 1, wherein the at least one permanent magnet is adapted to move freely in the coil plane within the boundaries of the scavenger.

6. The electromagnetic energy scavenger according to claim 1, adapted for, upon arbitrary mechanical movement of the electromagnetic scavenger, inducing sliding of the at least one permanent magnet in a sliding plane parallel to the coil plane.

7. The electromagnetic energy scavenger according to claim 1, wherein the plurality of coils are arranged in at least one one-dimensional array or in a two-dimensional array.

8. The electromagnetic energy scavenger according to claim 1, further comprising:
repelling means for confining the movement of the at least one permanent magnet to a predetermined zone within the boundaries of the scavenger, the predetermined zone overlaying at least one of the one or more coils.

9. The electromagnetic energy scavenger according to claim 8, wherein the repelling means are arranged along a perimeter of the predetermined zone.

10. The electromagnetic energy scavenger according to claim 8, wherein the repelling means comprise at least one of a magnetic springs and a mechanical cantilever.

11. The electromagnetic energy scavenger according to claim 1, further comprising:
means for restricting movement of the at least one permanent magnet in a direction non-parallel to the coil plane.

12. The electromagnetic energy scavenger according to claim 11, wherein the means for restricting movement in a direction non-parallel to the coil plane comprises at least one plate substantially parallel to the coil plane.

13. The electromagnetic energy scavenger according to claim 12, wherein the at least one plate comprises a low-friction coating for minimizing energy losses during motion of the at least one permanent magnet.

14. A method for converting kinetic energy into electrical energy, the method comprising:
mechanically moving at least one permanent magnet with respect to one or more coils lying in a coil plane, wherein mechanically moving the at least one permanent magnet provides a free movement of the at least one magnet in a plane parallel to the coil plane, and wherein at least one soft magnetic layer is provided in a plane parallel to the coil plane for improving the magnetic flux confinement to the at least one coil, the at least one soft magnetic layer comprising a plurality of segments.

15. The method according to claim 14, wherein providing a free movement comprises providing a free sliding movement of the permanent magnet with respect to the one or more coils.
